(19) United States
(12) Patent Application Publication
(10) Pub. No.: US 2010/0230207 A1
(43) Pub. Date: Sep. 16, 2010

(54) BOARDING BRIDGE FALL PROTECTION SYSTEM

(76) Inventors: James Larson, Lloyd Harbor, NY (US); James Breland, Ponchatoula, LA (US)

Correspondence Address: HOFFMANN & BARON, LLP, 6900 JERICHO TURNPIKE, SYOSSET, NY, 11791, US

(21) Appl. No.: 12/404,001

(22) Filed: Mar. 13, 2009

(51) Int. Cl. A62B 35/04; A62B 35/00

(52) U.S. Cl. 182/5; 182/230; 182/3

(57) ABSTRACT

A boarding bridge fall protection system including a double-line support apparatus is disclosed. The double-line support apparatus include a first anchor block, a second anchor block and a double-lifeline system. The first anchor block is configured to be disposed at a first distal end of a tunnel section of a boarding bridge. The second anchor block is configured to be disposed at a second distal end of the tunnel section. The double-lifeline system includes a plurality of lifelines configured to operatively connect to the first anchor block and the second anchor block.

### TECHNICAL FIELD

The present application relates to fall protection systems. More specifically, the present application is directed to a boarding bridge fall protection system.

### BACKGROUND

Boarding bridges, also known as loading bridges or jet bridges, enable passengers to board an airplane from an airport terminal gate (e.g., disposed at first-level) and disembark the airplane to the airport terminal gate, without exposure to the outside. Boarding bridges exhibit various configurations depending on factors such as airport terminal design, airplane sill height, fueling position, and other structural or operational requirements. Boarding bridges generally have retractable telescoping designs that include multiple tunnel sections allowing the boarding bridges to retract and extend (or telescope) to desired lengths to couple with arriving airplanes of different dimensions. The boarding bridges also generally have two end or terminal sections, a rotunda section that connects the telescoping tunnel sections to the airport terminal gate and a cab section that connects the telescoping tunnel sections to the airplane.

Maintenance of boarding bridges is required to maintain their safe operation. Maintenance activities may include repairing motors, replacing gear boxes, adjusting tunnel rollers, replacing ball screws, and many other tasks. Often, maintenance activities require a maintenance technician to work at various heights and some maintenance activities may require the maintenance technician to work on the roof of the boarding bridge, necessitating the use of a boarding bridge fall protection system. Some maintenance activities may also require more than one maintenance technician to work on the roof in the same general area.

Generally, a boarding bridge fall protection system includes a single-line support apparatus, which includes a single line tensioned between terminal blocks secured centrally at distal ends of a tunnel section of a boarding bridge, capable of supporting one maintenance technician via a lanyard secured to a harness worn by the maintenance technician. The lanyard generally includes a single cord that secures the maintenance technician (via the harness) to the single line of the single-line support apparatus.

One single-line support apparatus is generally disposed atop each tunnel section of the boarding bridge. In order for the maintenance technician to transition between the tunnel sections, the maintenance technician is required to disconnect the single cord of the lanyard from the line of a first single-line support apparatus disposed on a first tunnel section and reattach the single cord to the line of a second single-line support apparatus disposed on a second tunnel section. The unsecured transition between tunnel sections presents a hazard.

Furthermore, the single-line support apparatus of a tunnel section creates a hazard when more than one technician is required for maintenance activities in the same general area of the tunnel section, as only one maintenance technician may safely secure the single cord of the maintenance technician's lanyard to the single line of the single-line support apparatus.

### SUMMARY

In accordance with an embodiment, a boarding bridge fall protection system that includes a double-line support apparatus is disclosed. The double-line support apparatus includes a first anchor block, a second anchor block and a double-lifeline system. The first anchor block is configured to be disposed at a first distal end of a tunnel section of a boarding bridge. The second anchor block is configured to be disposed at a second distal end of the tunnel section. The double-lifeline system includes a plurality of lifelines configured to operatively connect to the first anchor block and the second anchor block.

In accordance with another embodiment, a lanyard is provided. The lanyard includes a first cord and a second cord. The first cord has a first length and the second cord has a second length different than the first length.

In accordance with a further embodiment, a method of providing boarding bridge fall protection is disclosed. The method includes securing a first cord of a lanyard to a lifeline disposed on a first tunnel section of a boarding bridge. The method further also includes securing a second cord of the lanyard to a lifeline disposed on a second tunnel section of the boarding bridge. The method further includes disconnecting the first cord of the lanyard from the lifeline of the first tunnel section.

In accordance with yet another embodiment, a boarding bridge fall protection system is disclosed. The system includes first double-line support apparatus, a second double-line support apparatus, a harness, and a lanyard. The first double-line support apparatus is secured to a first tunnel section of a first width. The first double-line support apparatus includes a first plurality of lifelines. The second double-line support apparatus is secured to a second tunnel section of a second width different than the first width. The second double-line support apparatus includes a second plurality of lifelines. The harness is configured to secure to a maintenance technician. The lanyard is configured to operatively secure to the harness. The lanyard further includes a first cord of a first length and a second cord of a second length different than the first length. The first cord is configured to operatively secure the lanyard to one of the first plurality of lifelines. The second cord is configured to operatively secure the lanyard to one of the second plurality of lifelines while the first cord is secured to one of the first plurality of lifelines.

### BRIEF DESCRIPTION OF DRAWINGS

Some embodiments are illustrated by way of example and not limitation in the figures of the accompanying drawing in which:

FIG. 1 is a top view of an example double-line support apparatus of a boarding bridge fall protection system;

FIG. 2 is a side view of an example anchor block of the double-line support apparatus of FIG. 1 that is secured to a roof of a tunnel section of a boarding bridge;

FIG. 3 is a top view of an example terminal section anchor block assembly of a boarding bridge fall protection system;

FIG. 4 is a side view of an example terminal section anchor block assembly that is secured to a roof of a terminal section of a boarding bridge;

FIG. 5 is a top view of an example boarding bridge that secures at least one example double-line support apparatus of FIG. 1 and at least one terminal section anchor block assembly FIG. 3 or FIG. 4;

FIG. 6 illustrates an example lanyard of a boarding bridge fall protection system;

FIG. 7 illustrates example operation of an example boarding bridge fall protection system;

FIG. 8 illustrates example operation of an example boarding bridge fall protection system; and

FIG. 9 illustrates example operation of an example boarding bridge fall protection system.

### DETAILED DESCRIPTION

A boarding bridge fall protection system and a method of providing boarding bridge fall protection are disclosed. In the following description, for the purposes of explanation, numerous specific details are set forth in order to provide a thorough understanding of particular embodiments. It will be evident to one skilled in the art, however, that certain embodiments may be practiced without these specific details.

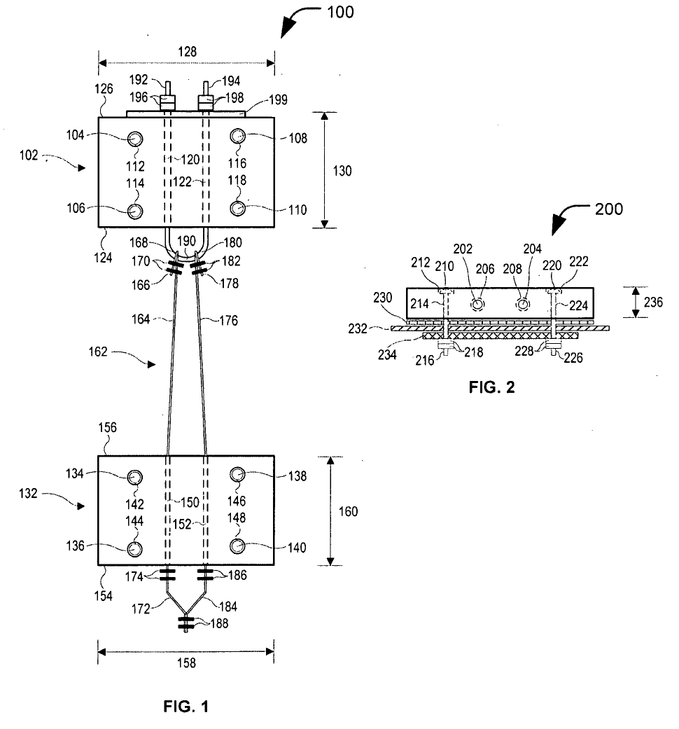

FIG. 1 is a top view of an example double-line support apparatus 100 of a boarding bridge fall protection system. The example double-line support apparatus 100 is configured to be disposed on and secured to a tunnel section (e.g., telescoping tunnel section) of a boarding bridge. The example double-line support apparatus 100 is generally disposed centrally with respect to a width of the tunnel section and extends along a length of the tunnel section from a first distal end to a second opposite distal end of the tunnel section. The example double-line support apparatus 100 may be secured to each of a plurality of tunnel sections of the boarding bridge, providing a continuous support configuration along the tunnel sections of the boarding bridge. The double-line support apparatus 100 is configured to secure two maintenance technicians on a tunnel section of the boarding bridge, providing the maintenance technicians with fall protection. More specifically, this configuration allows two maintenance technicians to secure their respective lanyards to the double-line support apparatus 100 and work simultaneously on one tunnel section of the boarding bridge.

The example double-line support apparatus 100 includes a first anchor block 102, a second anchor block 132, and a double-lifeline system 162. The first anchor block 102 is configured to be disposed centrally at a first distal end of a tunnel section and further configured to be secured to the tunnel section, as shown in greater detail in and described in connection with FIG. 2. The first anchor block 102 is also configured to secure the double-lifeline system 162, as will be described in greater detail below.

The first anchor block 102 has a length 128 and a width 130. The length 128 of the first anchor block 102 may be about 6.5 inches and the width 130 of the first anchor block 102 may be about 4 inches. Alternate length and width dimensions may be used for different boarding bridge designs. The first anchor block 102 may be made of aluminum, stainless steel or other material. The first anchor block 102 may have a minimum yield of about 35 KSI and a minimum tensile strength of about 38 KSI. The first anchor block 102 may be configured to have alternate minimum yield and minimum tensile strength, as may be desired for a particular boarding bridge fall protection system.

The first anchor block 102 includes through-holes 104, 106, 108, 110, respective countersink regions 112, 114, 116, 118, and channels 120, 122. The through-holes 104, 106, 108, 110, and the respective countersink regions 112, 114, 116, 118, are configured to receive fasteners such as bolts, screws, or other conventional fasteners to secure the first anchor block 102 to a roof of the tunnel section. The first anchor block 102 may have any number of through-holes and respective counter-sink regions configured to receive fasteners to secure the first anchor block 102 to the roof of the tunnel section.

The channels 120, 122 of the first anchor block 102 are configured to receive a portion of the double-lifeline system 162. The channels 120, 122 are configured to extend from and through a first end 124 to and though a second end 126 of the first anchor block 102. As will be described in greater detail below, the channels 120, 122 may receive a u-bolt member 190 of the double-lifeline system 162 that is secured to the first anchor block 102.

The second anchor block 132 of the example double-line support apparatus 100 is configured to be disposed centrally at a second distal end of a tunnel section and further configured to be secured to the tunnel section, as shown in greater detail in FIG. 2 below. The second anchor block 132 is also configured to secure the double-line system 162, as will be described in greater detail below

The second anchor block 132 has a length 158 and a width 160. The length 158 and the width 160 of the second anchor block 132 may be similar to or different than the length 128 and the width 130 of the first anchor block 102. Alternate length and width dimensions of the second anchor block 132 may be used for different boarding bridge designs. The second anchor block 132 may be made of similar materials as the first anchor block 102 (e.g., aluminum, stainless steel or other material). The second anchor block 132 may also have similar minimum yield and minimum tensile strength characteristics as the first anchor block 102 (e.g., a minimum yield of about 35 KSI and a minimum tensile strength of about 38 KSI). Similarly, the second anchor block 122 may be configured to have alternate minimum yield and minimum tensile strength, as may be desired for a particular boarding bridge fall protection system.

The second anchor block 132 includes through-holes 134, 136, 138, 140, respective countersink regions 142, 144, 146, 148, and channels 150, 152. The through-holes 134, 136, 138 and 140, and respective countersink regions 142, 144, 146, 148 of the second anchor block 132 may be configured similarly to or different than the through-holes 104, 106, 108, 110, and their respective countersink regions 112, 114, 116, 118 of the first anchor block 102. The second anchor block 132 may have any number of through-holes and respective countersink regions configured to receive fasteners to secure the second anchor block 102 to a roof of the tunnel section.

The channels 150, 152 are configured to receive and secure a portion of the double-lifeline system 162. The channels 150, 152 are further configured to extend from and through a first end 154 to and though a second end 156 of the second anchor block 132. As will be described in greater detail below, the channels 150, 152 may receive and secure terminal ends 172, 184 of respective line 164, 176 of the double-lifeline system 162.

The double-lifeline system 162 is configured to span a distance between and connect securely to the first anchor block 102 and to the second anchor block 132 disposed at distal (or terminal) ends of a tunnel section of a boarding bridge. The double-lifeline system 162 includes lines 164, 176, thimbles 168, 180, joining members 170, 174, 182, 186, 188, securing members 196, 198, and optionally, a backing plate 199.

The lines 164, 176 are configured to connect to the first anchor block 102 at one distal end of the tunnel section and to the second anchor block 132 at the opposite distal end of the tunnel section. Each of the lines 164, 176 is further configured to receive and secure a cord of a lanyard, facilitating concurrent fall protection for two maintenance technicians (one maintenance technician per line) and allowing the maintenance technicians to work in the same general area or different areas of the tunnel section. The lines 164, 176 may be generally the same length and may be made of wire rope. The wire rope may be made of stainless steel and may be 5/16 of an inch in diameter. Alternate dimensions and materials may be used for the lines 164, 176. The lines are sized and tensioned to secure two maintenance technicians, providing the maintenance technicians with fall protection. The lines 164, 176 include terminal ends 166, 172, 178, 184, which will be described in greater detail below.

The u-bolt member 190 is configured to operatively receive the lines 164, 176 and is further configured to operatively connect lines 164, 176 of the double-lifeline system 162 to the first anchor block 102. The u-bolt member 190 is further configured to allow for deflection of lines 164, 176 in a plurality of directions (e.g., resulting from maintenance technicians applying loads to the double-lifeline system 162 in various directions). The u-bolt member 190 includes terminal ends 192, 194 secured by securing members 196, 198 (e.g., double nuts). The u-bolt member 190 is received through the channels 120, 122 in the first end 124 of the first anchor block 102, such that the terminal ends 192, 194 of the u-bolt member 190 protrude through the channels 120, 122 at the second end 126 of the first anchor block 102. The terminal ends 192, 194 of u-bolt member 190 are threaded so that the u-bolt member 190 may be secured to the first anchor block 102 via the securing members 196, 198, such as double nuts.

In one embodiment, a backing plate 199 may be provided. The backing plate 199 is configured to prevent dislodgement or movement of the u-bolt member 190 with respect to the first anchor block 102. The backing plate 199 includes through-holes (not shown) configured to receive the terminal ends 192, 194 of the u-bolt member 190 through the through-holes such that the terminal ends 192, 194 may be secured via the securing members 196, 198. The backing plate 199 may be made steel or other material. The backing plate may have a minimum yield of about 35 KSI and minimum tensile strength from about 58 KSI to about 80 KSI.

The joining members 170, 182 are configured to operatively connect the respective lines 164, 176 to the u-bolt member 190. More specifically, the terminal ends 166, 178 of the respective lines 164, 176 are looped through the u-bolt member 190 and secured to the lines 164, 176 by the joining members 170, 182, respectively. The joining members 170, 182 may be, for example, crimps and/or clips or other joining members configured to securely couple and attach the respective looped ends 166, 178 to the lines 164, 176. At least two joining members may be used to secure each of the terminal ends 166, 178 to the respective lines 164, 176.

The thimbles 168, 180 are configured to prevent looped ends 166, 178, from folding, crimping, and potentially breaking when loads are applied to the double-lifeline system 162 (e.g., maintenance technicians using the double-lifeline system 162). The thimbles 168, 180 are also configured to prevent chafing of the looped ends 166, 178, against the u-bolt member 190 when the lines 164, 176 are deflected in a plurality of directions in relation to the u-bolt member 190 (e.g., resulting from maintenance technicians applying loads to the double-lifeline system 162 in various directions).

The lines 164, 176 of the double-lifeline system 162 are further configured connect to the second anchor block 132. In one embodiment, the lines 164, 176 are received through channels 150, 152 in the first end 156 of the second anchor block 132, such that the terminal ends 172, 184 of the lines 164, 176 protrude through channels 150, 152 at the second end 154 of the second anchor block 132. The terminal ends 172, 184 of the lines 164, 176 may be secured to the second anchor block 132 by the joining members 174, 186, respectively. The terminal ends 172, 184 of the lines 164, 176 may be further secured to one another by the joining members 188. The joining members 174, 186, 188 may be, for example, crimps and/or clips, or other joining members configured to securely couple to attach the respective terminal ends 172, 184 of the lines 164, 176 to the second anchor block 132 and to each other. At least two joining members may be used to secure each of terminal ends 172, 184 to the second anchor block 132.

In another embodiment, the lines 164, 176 may be secured to the second anchor block 132 using a combination of a u-bolt and respective joining members as described above in relation to securing the lines 164, 176 to the first anchor block 102.

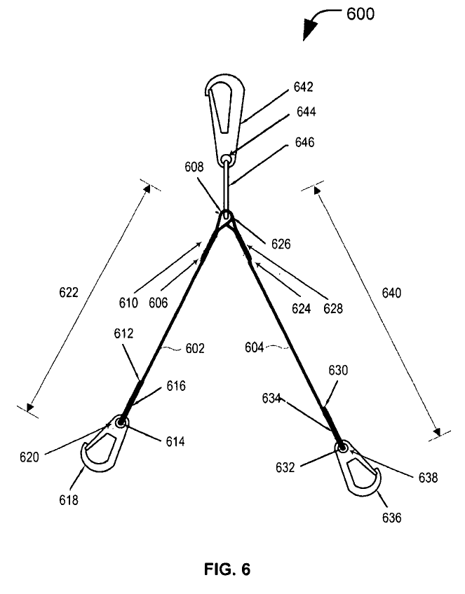

In operation, one or both ends of the double-lifeline system 162 (e.g., terminal ends 196, 198 and terminal ends 172, 184) may be tensioned to provide an appropriate and configurable amount of tension to the double-lifeline system 162. The tension may provide an appropriate amount of deflection and yield to provide fall protection when at least one maintenance technician is secured to the double-lifeline system 162 via a lanyard and a harness, which will be described in greater detail with reference to FIGS. 6, 8 and 9. For example, the double-lifeline system 162 (each constituent element) may have a minimum yield of about 30 KSI and a minimum tensile strength of about 75 KSI.

FIG. 2 is a side view of an example anchor block 200 of the double-line support apparatus 100 of FIG. 1 that is secured to a roof 232 of a tunnel section (e.g., telescoping tunnel section) of a boarding bridge. The example anchor block 200 is similar to the first anchor block 102 and the second anchor block 132, illustrated in FIG. 1. The example anchor block 200 is configured to operatively connect to a tunnel section of a boarding bridge and is further configured to operatively connect two lifelines, such as lines 164, 176 of FIG. 1. The anchor block 200 is also configured to elevate the lifelines above the roof of the tunnel section of the boarding bridge to facilitate connection of a cord of a lanyard to the lifelines 164, 176.

The anchor block 200 includes channels 202, 204, through-holes 214, 224 and respective countersink regions 212, 222. The anchor block 200 has a height 236 of about ¾ of an inch. Alternate heights may be used for different boarding bridge designs.

The anchor block 200 is configured to secure the double-line system 162 through the channels 202, 204. The channels 202, 204 are similar to the channels 120, 122, 150, 152 of the first anchor block 102 and the second anchor block 132, respectively, as described in relation to FIG. 1 above. In one embodiment, channels 202, 204 may be configured to operatively receive the u-bolt member 190. In another embodiment, channels 202, 204 may be configured to operatively receive terminal ends 172, 184 of lines 164, 176 of the double-line support apparatus 100. Channel liners 206, 208 may be provided to mitigate chafing of the lines 164, 176 against edges of the channels 202, 204.

The through-holes 214, 224 and their respective countersink regions 212, 222 are configured to operatively receive bolts 210, 220, respectively. The countersink regions 212, 222 are configured to provide recess the bolts 210, 220, within the anchor block 200. The bolts 210, 220 are configured to secure the anchor block 200 to roof 232 of a tunnel section of a boarding bridge. The terminal ends 216, 226 of the respective bolts 210, 220 are configured to extend through the roof 232 and are threaded to receive the securing members 218, 228, such as double nuts. Although only through-holes 214, 224, countersink regions 212, 222, and bolts 210, 220 are shown in the side view of FIG. 2, it is understood that any number of through holes, countersink regions and bolts may be provided to secure the anchor block 200 to roof 232 of a tunnel section of a boarding bridge.

In one embodiment, the anchor block 200 may be disposed atop a gasket 230, which separates the anchor block 200 from the roof 232. The gasket 230 is configured to provide a seal between the roof 232 and the anchor block 200 and is further configured to prevent abrasion between the anchor block 200 and the roof 232. The gasket 230 may further include through-holes (not shown) that receive bolts 210, 220. In another embodiment, a flat plate 234 may be disposed on an undersurface of the roof 232 and configured to prevent loosening and dislodgement of bolts 210, 220 from anchor block 200 and roof 232. The flat plate 234 includes through-holes (not shown) configured to receive the terminal ends 216, 226 of the bolts 210, 200 such that the bolt ends 216, 226 may be secured using the securing members 218, 228 (e.g., double nuts).

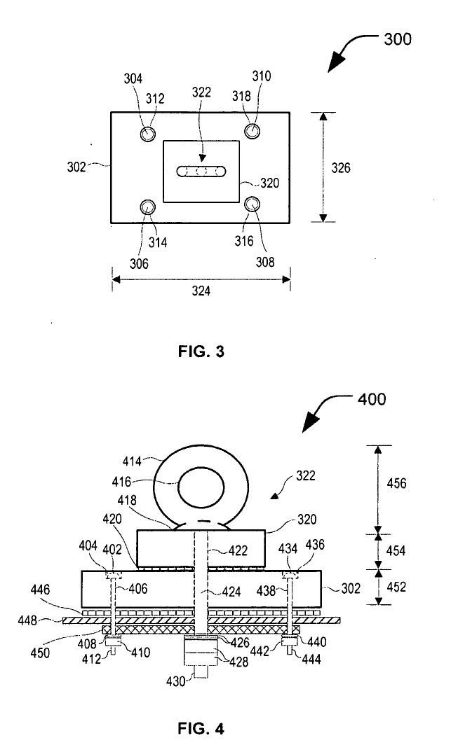

FIG. 3 is a top view of an example terminal section anchor block assembly 300 of a boarding bridge fall protection system. The terminal section anchor block assembly 300 is configured to operatively attach to a roof of a terminal section (e.g., rotunda and cab) of a boarding bridge and is further configured to operatively receive and secure a cord of at least one maintenance technician's lanyard, affording the at least one maintenance technician the ability to work safely on the terminal section of the boarding bridge. The terminal section anchor block assembly 300 includes a terminal anchor block 302, a block washer 320, and an eyebolt 322.

The terminal anchor block 302 includes through-holes 304, 306, 308, 310 and respective countersink regions 312, 314, 316, 318, which are configured to receive fasteners such as bolts, screws, or other conventional fasteners to secure the terminal anchor block 302 to a roof of a tunnel section. The terminal anchor block 302 has a length 324 and a width 326, the dimensions of which may be similar to those of first anchor block 102 and the second anchor block 132 of the example double-line support apparatus 100 of FIG. 1. Alternate length and width dimensions may be used for different boarding bridge designs.

The block washer 320 is configured to elevate the eyebolt 322 and is further configured to mitigate the dislodgement of the eyebolt 322 from the terminal anchor block 300. The block washer 320 includes a through-hole (not shown) to operatively receive the eyebolt 320 through the block washer 320.

The eyebolt 322 is configured to receive and secure a cord of a lanyard of at least one maintenance technician, facilitating fall protection of the at least one maintenance technician working on a terminal section (e.g., e.g., rotunda and cab) of a boarding bridge.

FIG. 4 is a side view of a terminal section anchor block assembly 400 that is secured to a roof 448 of a terminal section (e.g., rotunda, cab) of a boarding bridge. The terminal section anchor block assembly 400 is similar to the terminal section anchor block assembly 300 illustrated in FIG. 3. The terminal section anchor block assembly 400 is configured to be secured at a central point of the terminal section of the boarding bridge. The terminal section anchor block assembly 400 is further configured to receive and secure a cord of at least one maintenance technician's lanyard, affording the at least one maintenance technician the ability to work safely on the terminal section of the boarding bridge.

The terminal section anchor block assembly 400 includes a terminal anchor block 302, a block washer 320, and an eyebolt 322. The terminal section anchor block assembly 400 has an overall length of about 6½ inches, a width of about 4 inches, and a height of about 4 inches. The dimensions of the constituent elements of the terminal section anchor block assembly 400 will be described in greater detail below.

The terminal anchor block 302 includes through-holes 406, 438, and respective countersink regions 404, 436, which are configured to receive fasteners, such as bolts 402, 434, to secure the terminal anchor block 302 to the roof 448 of a tunnel section. Although only through-holes 406, 438, countersink regions 404, 436, and bolts 402, 434 are shown in the side view of FIG. 4, it is understood that any number of through holes, countersink regions and bolts may be provided to secure the anchor block 302 to roof 448 of a terminal section (e.g., rotunda, cab) of a boarding bridge. The terminal anchor block 302 has length and width similar to the length and width of terminal anchor block 300 of FIG. 3 (e.g., about 6½ inches by about 4 inches) and a height 452 of about ¾ inches.

The bolts 402, 434 are configured to secure the anchor block 302 to roof 448 of a terminal section of a boarding bridge. The terminal ends 412, 444 of the respective bolts 402, 434 are configured to extend through the roof 448 and are threaded to receive the respective securing members 410, 442, such as nuts. In one embodiment, respective washers 408, 440 may be disposed on the terminal ends 412, 444 of the bolts 402, 434 and then secured by respective securing members 410, 442.

The block washer 320 has a length of about 3 inches, a width of about 3 inches, and a height 454 of about ¾ inches. The block washer 320 elevates the eyebolt 322 above the terminal anchor block 302 and the roof 448 to facilitate at least one maintenance technician in securing a cord of a lanyard to the eyebolt 322, and further mitigates the dislodgement of the eyebolt 322 from the terminal anchor block 302 (e.g., resulting from maintenance technicians applying loads to eyebolt 322).

The eyebolt 322 is disposed atop the block washer 320 and facilitates at least one maintenance technician in securing a cord of a lanyard to the eyebolt 322. The eyebolt 322 includes a head portion 414 having an opening 416, a base portion 418 and a bolt portion 422. The head portion 414 and the base portion 418 of the eyebolt 322 have a height 456 of about 2½ inches above the block washer 320. The head portion 414 is configured to receive and secure a cord of at least one maintenance technician's lanyard. The opening 416 of the head portion 414 has a diameter of about 1½ inches. An alternate diameter may be used for different boarding bridges or lanyard designs. The base portion 418 is coplanar with block washer 320 to provide stability to the head portion 414 and mitigate the dislodgement of the eyebolt 322.

The bolt portion 422 of the eyebolt 430 extends through the block washer 320 and the terminal anchor block 302 via a coincident channel 424. The bolt portion 422 includes a terminal end 430 that is threaded to receive at least one washer 426 and securing members 428, such as double nuts.

In one embodiment, the block washer 320 may be disposed atop a block gasket 420. The block gasket 420 is configured to provide a seal between and prevent chafing of or abrasion between the block washer 320 and the terminal anchor block 302. The gasket 420 may further include a through-hole (not shown) that receives the bolt portion 422.

In another embodiment, the terminal anchor block 302 may be disposed atop a roof gasket 446, which separates the terminal anchor block 302 from the roof 448. The gasket 446 provides a seal between the roof 448 and the terminal anchor block 302 and prevents abrasion between the anchor block 302 and the roof 448. The roof gasket 446 may further include through-holes (not shown) that receive bolts 402, 434 and bolt portion 422 of the eyebolt 322.

In yet another embodiment, a flat plate 450 may be disposed on an undersurface of the roof 448 to prevent loosening and dislodgement of bolts 210, 220 and bolt portion 422 from the terminal anchor block 302 and roof 448. The flat plate 450 includes through-holes (not shown) configured to receive the terminal ends 412, 444 of the bolts 402, 434 and terminal end 430 of bolt portion 422, such that the terminal ends 412, 444, 430 may be secured using the securing members 410, 442, 428.

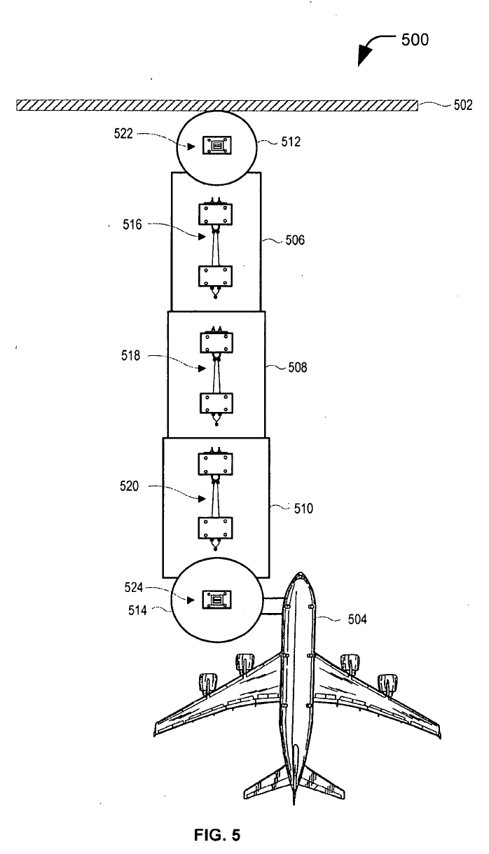

FIG. 5 is a top view of an example boarding bridge 500 that secures at least one double-line support apparatus 100 and at least one terminal section anchor block assembly 300 or 400. The example boarding bridge 500 is configured to extend from an airport terminal 502 (e.g., airport terminal gate) to an airplane 504. The boarding bridge 500 includes tunnel sections 506, 508, 510 (e.g., telescoping tunnel sections) and terminal sections 522, 524 (e.g., rotunda and cab sections).

As illustrated FIG. 5, double-line support apparatuses 516, 518, 520 are disposed approximately centrally along the length of each of the tunnel sections 506, 508, 510 and are configured to provide at least one maintenance technician (secured to a tunnel section via a lanyard and harness) with fall protection in relation to the tunnel sections 506, 508, 510. Each of the double-line support apparatuses 516, 518, 520 may be similar to the double-line support apparatus 100, as described above in relation to FIG. 1.

Terminal section anchor block assemblies 522, 524 are disposed approximately centrally on terminal sections 512, 514 and are configured to provide at least one maintenance technician (secured to an end section via a lanyard and harness) with fall protection in relation to the terminal sections 512, 514. Each of the terminal section anchor block assemblies 522, 524 may be similar to terminal section anchor block assembly 300 or 400.

FIG. 6 illustrates an example lanyard 600 of a boarding bridge fall protection system. The lanyard 600 is configured to provide a secure connection to a double-line attachment apparatus 516, 518 or 520 of FIG. 5 and to a terminal section anchor block assembly 512 or 524 of FIG. 5. The lanyard 600 is further configured to provide a secure connection to a harness (not shown) worn by a maintenance technician. The lanyard 600 is also configured to provide a secure transition between double-line attachment apparatuses 516, 518 or 520, and also between a terminal section anchor block assembly 522 or 524 and a respective double-line attachment apparatus 516 or 520.

The lanyard 600 includes a first cord 602, second cord 604, a first lifeline connector 618, a second lifeline connector 636, a harness connector 642, and in some embodiments an extension member 646.

The first cord 602 of the lanyard 600 has a length 622 of about 48½ inches and the second cord 604 has a length 640 of about 50⅜ inches. In one embodiment, the lengths 622, 640 of the respective cords 602, 604 may be equal. Alternate lengths may be used for different lanyard or boarding bridge designs. Cords 602, 604 facilitate secure transition between double-line attachment apparatuses 516, 518 or 520, and between a terminal section anchor block assembly 522 or 524 and a respective double-line attachment apparatus 516 or 520. The different lengths 622, 640 of the cords 602, 604 provide fall protection on tunnel sections of variable widths, such as tunnel sections 506, 508 and 510. Additional cords of varied lengths may be provided. The cords may be color coded for each tunnel section.

The first cord 602 includes a first terminal end 606 looped around a thimble 608 and through the extension member 646. The first cord 602 also includes a second terminal end 612 looped around a thimble 614 and through hole 620 of the first lifeline connector 618. The first terminal end 606 is secured to the first cord 602 by at least one joining member 610 and the second terminal end 612 is secured to the first cord 602 by at least one joining member 616. The thimbles 608, 614 are configured to prevent the terminal ends 606, 612 of the first cord 602 from folding, crimping, chafing and potentially breaking when loads are applied to the lanyard 600 (e.g., maintenance technician using the lanyard). The joining members 610, 616 may be, for example, crimps, clips, or other joining members configured to securely couple or secure the respective ends 606, 612 to the first cords 602.

Similarly, the second cord 604 includes a first terminal end 624 looped around a thimble 626 and through the extension member 646. The second cord 604 also includes a second terminal end 630 looped around a thimble 632 and through hole 638 of the second lifeline connector 636. The first terminal end 624 is secured to the second cord 604 by at least one joining member 628 and the second terminal end 630 is secured to the second cord 604 by at least one joining member 634. The thimbles 626, 632 are configured to prevent the terminal ends 624, 630 of the second cord 604 from folding, crimping, chafing and potentially breaking when loads are applied to the lanyard 600 (e.g., maintenance technician using the lanyard). The joining members 626, 632 may be, for example, crimps, clips, or other joining members configured to securely couple or secure the respective ends 624, 630 to the second cords 604.

The extension member 646 is configured to operatively connect the cords 602, 604 to the harness connector 642. More specifically, the extension member 646 is looped through hole 644 of the harness connector 642. The extension member 646 may be a carabiner or another extension member (e.g., screw-type loop or spring-type loop) configured to securely connect the cords 602, 604 and the harness connector 642. In some embodiments, the extension member 646 may be omitted, and the first terminal end 606 may be looped around thimble 608 through hole 644 of the harness connector 642, and the first terminal end 624 may be looped around thimble 626 through hole 644 of the harness connector 642.

The harness connector 642 is configured to operatively connect the lanyard 600 to a harness (not shown) worn by a maintenance technician. Each of the lifeline connectors 618, 636 is configured to operatively connect to a lifeline of a double-line support apparatus (e.g., double-lifeline support apparatus 100 of FIG. 1). Connectors 618, 636, 642 may be, for example, double locking snap hooks or double locking safety rebar hooks. Connectors 618, 636, 642 are configured to be capable of handling a load of about 5000 pounds.

In operation, the lanyard 600 is secured to a harness (not shown) worn by a maintenance technician via the harness connector 642. Upon maintenance work required atop a tunnel section (e.g., telescoping tunnel section or a terminal tunnel section) of a boarding bridge, the maintenance technician secures the first cord of the lanyard 600 to a double-line support apparatus (e.g., double-line support apparatus 516, 518, 520 of FIG. 5) or to a terminal section anchor block assembly (e.g., terminal section anchor block assembly 522, 524 of FIG. 5). For example, the maintenance technician may secure the lifeline connector 618 of lanyard 600 to a lifeline (e.g., lifeline 164 illustrated in FIG. 1) of the double-line support apparatus 516 on tunnel section 506 of FIG. 5. As described hereinabove, two maintenance technicians may securely attach to the same double-line support apparatus or to the terminal section anchor block assembly.

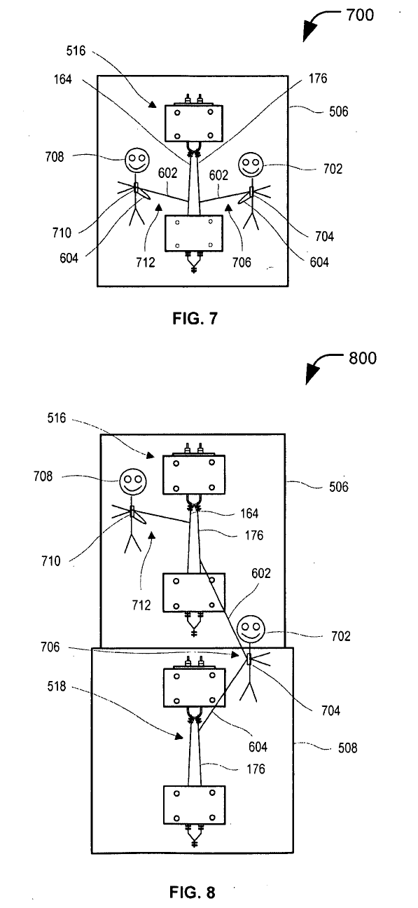

FIG. 7 illustrates example operation of an example fall protection system 700. More specifically, the example fall protection system 700 includes an example double-line support apparatus, at least one example lanyard, and at least one example harness. As particularly illustrated in FIG. 7, maintenance technician 702 is secured via harness 704 and cord 602 of the lanyard 706 to lifeline 176 of the double-lifeline support apparatus 516 that is disposed atop tunnel section 506 of FIG. 5. As is further illustrated in FIG. 7, maintenance technician 708 is secured via harness 710 and cord 602 of the lanyard 712 to lifeline 164 of the double-lifeline support apparatus 516 that is disposed atop tunnel section 506 of FIG. 5. It is noted that one of the other double-line support apparatuses 518, 520 disposed atop respective tunnel sections 508, 510 of FIG. 5 may be substituted for the double-lifeline support apparatus 516 disposed atop tunnel section 506. Lanyards 706, 712 are similar to the lanyard 600 of FIG. 6, described in detail with reference to FIG. 6.

In the example operation illustrated in FIG. 7, the maintenance technicians 702, 704 may perform maintenance activities on the same tunnel section 506 at the same time. This mitigates the hazard of prior art fall protection systems (e.g., single lifeline support apparatus), where multiple maintenance technicians 702, 704 could not work hazard-free on the same tunnel section 506 at the same time.

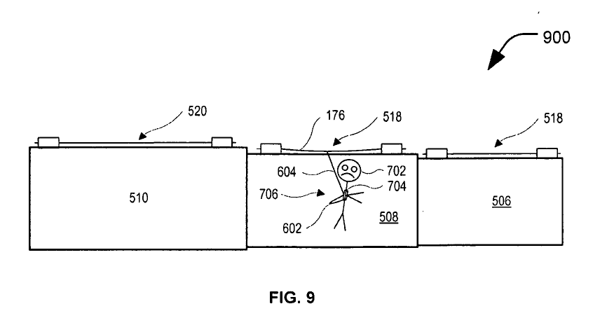

FIG. 8 illustrates example operation of an example fall protection system 800. The example fall protection system 800 includes a plurality of example double-line support apparatuses, at least one example lanyard, and at least one example harness. As particularly illustrated in FIG. 8, maintenance technician 702 is secured via harness 704 and cord 602 of the lanyard 706 to lifeline 176 of the double-lifeline support apparatus 516 that is disposed atop tunnel section 506 of FIG. 5. As is further illustrated in FIG. 8, maintenance technician 708 is secured via harness 710 and cord 602 of the lanyard 712 to lifeline 164 of the double-lifeline support apparatus 516 that is disposed atop tunnel section 506 of FIG. 5.

During performance of maintenance activities, maintenance technician 702 may need to transition between double-lifeline support apparatus 516 disposed atop tunnel section 506 and double-lifeline support apparatus 518 disposed atop tunnel section 508. In order to do so, the maintenance technician 702 secures cord 604 of the lanyard 706 to lifeline 176 of the double-line support apparatus 518 and then disconnects cord 602 of the lanyard 706 from lifeline 176 of the double-lifeline support apparatus 516. Although the transition is described with respect to maintenance technician 702 and double-lifeline apparatuses 516, 518 disposed on respective tunnel sections 506, 608, the transition may likewise apply to maintenance technician 708, as well as to the transfer between other double-line support apparatuses 518, 520 disposed atop respective tunnel sections 508, 510 of FIG. 5.

Although not specifically illustrated in FIG. 8, example fall protection system 800 may further include a plurality of example terminal section anchor block assemblies, such as terminal section anchor block assemblies 522, 524. The transition may be similarly accomplished between a terminal section anchor block assembly 522 disposed atop terminal section 512 and double-lifeline support apparatus 516 disposed atop tunnel section 506, and between a terminal section anchor block assembly 524 disposed atop terminal section 514 and double-lifeline support apparatus 520 disposed atop tunnel section 5 10.

FIG. 9 illustrates example operation of an example fall protection system 900. The example fall protection system 900 includes at least one example double-line support apparatus, at least one example lanyard, and at least one example harness. As particularly illustrated in FIG. 9, the fall of maintenance technician 702 has been restrained via harness 704 and cord 604 of the lanyard 706 secured to lifeline 176 of the double-lifeline support apparatus 518 that is disposed atop tunnel section 508 of FIG. 5. As further illustrated in FIG. 9,lifeline 176 of the double-line support apparatus 518 and the cord 604 of the lanyard 706 are configured to support the weight of the maintenance technician 702 during and after a fall from the tunnel section 508. The lifeline 176 of the double-line support apparatus 518 provides sufficient tension resulting in an appropriate amount of deflection and yield to mitigate severe jerking upon the fall of the maintenance technician 702.

Thus, a boarding bridge fall protection system and a method of boarding bridge fall protection have been described. Although specific example embodiments have been described, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A boarding bridge fall protection system comprising:
a double-line support apparatus including:
a first anchor block configured to be disposed at a first distal end of a tunnel section of a boarding bridge;
a second anchor block configured to be disposed at a second distal end of the tunnel section; and
a double-lifeline system including a plurality of lifelines configured to operatively connect to the first anchor block and the second anchor block.

2. The boarding bridge fall protection system of claim 1, further comprising a lanyard including a plurality of cords, each of the plurality of cords configured to secure to a lifeline of the plurality of lifelines of the double-lifeline system.

3. The boarding bridge fall protection system of claim 2, wherein each cord of the plurality of cords includes a lifeline connector configured to secure the cord to a lifeline of the plurality of lifelines of the double-lifeline system.

4. The boarding bridge fall protection system of claim 2, further comprising a harness configured to operatively secure a maintenance technician to the lanyard.

5. The boarding bridge fall protection system of claim 4, wherein the lanyard includes a harness connector configured to secure the lanyard to the harness.

6. The boarding bridge fall protection system of claim 2, wherein a first cord of the plurality of cords has a first length and a second cord of the plurality of cords has a second different length than the first cord.

7. The boarding bridge fall protection system of claim 1, wherein the double-lifeline system includes a first u-bolt member configured to operatively connect the plurality of lifelines to the first anchor block.

8. The boarding bridge fall protection system of claim 7, wherein the double-lifeline system includes a second u-bolt member configured to operatively connect the plurality of lifelines to the second anchor block.

9. The boarding bridge fall protection system of claim 1, wherein the double-line support apparatus is disposed about a midpoint of the width of the tunnel section.

10. The boarding bridge fall protection system of claim 1, further comprising a terminal section anchor block assembly configured to be disposed at a midpoint of a tunnel section.

11. The boarding bridge fall protection system of claim 10, wherein the tunnel section is one of a cab and a rotunda of the boarding bridge.

12. The boarding bridge fall protection system of claim 10, wherein terminal section anchor block assembly comprises:
a terminal anchor block configured to be secured to a roof of the tunnel section;
a block washer configured to be disposed on the terminal anchor block; and
an eyebolt including a head portion, a base portion and a bolt portion, the base portion being configured to be disposed on the block washer, the head portion having an opening configured to secure a cord of a lanyard, and a bolt portion configured to secure the eyebolt and the block washer and the terminal anchor block to the roof of the tunnel section.

13. A lanyard comprising:
a first cord having a first length; and
a second cord having a second length different than the first length.

14. The lanyard of claim 13, further comprising a first lifeline connector configured to secure the first cord to a lifeline disposed on a first tunnel section of a boarding bridge.

15. The lanyard of claim 14, further comprising a second lifeline connector configured to secure the second cord to a lifeline disposed on a second tunnel section of the boarding bridge.

16. The lanyard of claim 13, further comprising a harness connector configured to secure the lanyard to a harness.

17. A method of providing boarding bridge fall protection, the method comprising:
securing a first cord of a lanyard to a lifeline disposed on a first tunnel section of a boarding bridge;
securing a second cord of the lanyard to a lifeline disposed on a second tunnel section of the boarding bridge; and
disconnecting the first cord of the lanyard from the lifeline of the first tunnel section.

18. The method of claim 17, further comprising securing the lanyard to a harness worn by a maintenance technician.

19. The method of claim 17, further comprising:
securing the first cord to a terminal section anchor block assembly; and
disconnecting the second cord of the lanyard from the lifeline of the second tunnel section.

20. A boarding bridge fall protection system comprising:
a first double-line support apparatus secured to a first tunnel section of a first width, the first double-line support apparatus including a first plurality of lifelines;
a second double-line support apparatus secured to a second tunnel section of a second width different than the first width, the second double-line support apparatus including a second plurality of lifelines;
a harness configured to secure to a maintenance technician; and
a lanyard configured to operatively secure to the harness, the lanyard including a first cord of a first length and a second cord of a second length different than the first length, the first cord being configured to operatively secure the lanyard to one of the first plurality of lifelines, the second cord being configured to operatively secure the lanyard to one of the second plurality of lifelines while the first cord is secured to one of the first plurality of lifelines.

21. The boarding bridge fall protection system of claim 20, further comprising a terminal section anchor block assembly secured to a terminal tunnel section, wherein the first cord is further configured to operatively secure the lanyard to terminal section anchor block assembly, while the second cord of the lanyard is secured to one of the second plurality of lifelines.
